(19) United States
(12) Patent Application Publication
(10) Pub. No.: US 2026/0254489 A1
(43) Pub. Date: Aug. 27, 2026

(54) APPARATUS, SYSTEM, AND METHOD OF COMMUNICATING OVER A MILLIMETERWAVE (MMWAVE) CHANNEL BASED ON INFORMATION COMMUNICATED OVER A SUB 10 GIGAHERTZ (GHZ) (SUB-10GHZ) CHANNEL

(71) Applicant: INTEL CORPORATION, Santa Clara, CA (US)

(72) Inventors: Thomas J. Kenney, Portland, OR (US); Laurent Cariou, Milizac (FR)

(73) Assignee: INTEL CORPORATION, Santa Clara, CA (US)

(21) Appl. No.: 18/870,648

(22) PCT Filed: Jun. 30, 2022
(86) PCT No.: PCT/US2022/035633

§ 371 Date: Nov. 30, 2024

(51) Int. Cl. H04B 7/06

(52) U.S. Cl. CPC H04B 7/0617

(57) ABSTRACT

For example, a wireless communication device may be configured to transmit a frame from a sub 10 Gigahertz (GHz) (sub-10 GHz) wireless communication station (STA) of the wireless communication device over a sub-10 GHz wireless communication channel, the frame including beamforming (BF) assistance information corresponding to a millimeterWave (mmWave) STA of the wireless communication device, the BF assistance information including orientation-based information corresponding to the mmWave STA, wherein the orientation-based information corresponding to the mmWave STA is based on an orientation of the mmWave STA; and to communicate by the mmWave STA one or more BF training frames over a mmWave wireless communication channel.

### TECHNICAL FIELD

Aspects described herein generally relate to communicating over a millimeterWave (mmWave) wireless communication channel based on information communicated over a sub 10 Gigahertz (GHz) (sub-10 GHz) wireless communication channel.

### BACKGROUND

Devices in a wireless communication system may be configured to communicate over a millimeterWave (mmWave) wireless communication channel. There is a need to provide a technical solution to support beamforming communications over the mmWave wireless communication channel.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a sector sweep procedure, in accordance with some demonstrative aspects.

FIG. 5 is a schematic flow-chart illustration of a method of communicating over a millimeterWave (mmWave) wireless communication channel based on information communicated over a sub 10 Gigahertz (GHz) (sub-10 GHz) wireless communication channel, in accordance with some demonstrative aspects.

FIG. 6 is a schematic flow-chart illustration of a method of communicating over an mmWave wireless communication channel based on information communicated over a sub-10 GHz wireless communication channel, in accordance with some demonstrative aspects.

FIG. 7 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D1.5 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), March 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

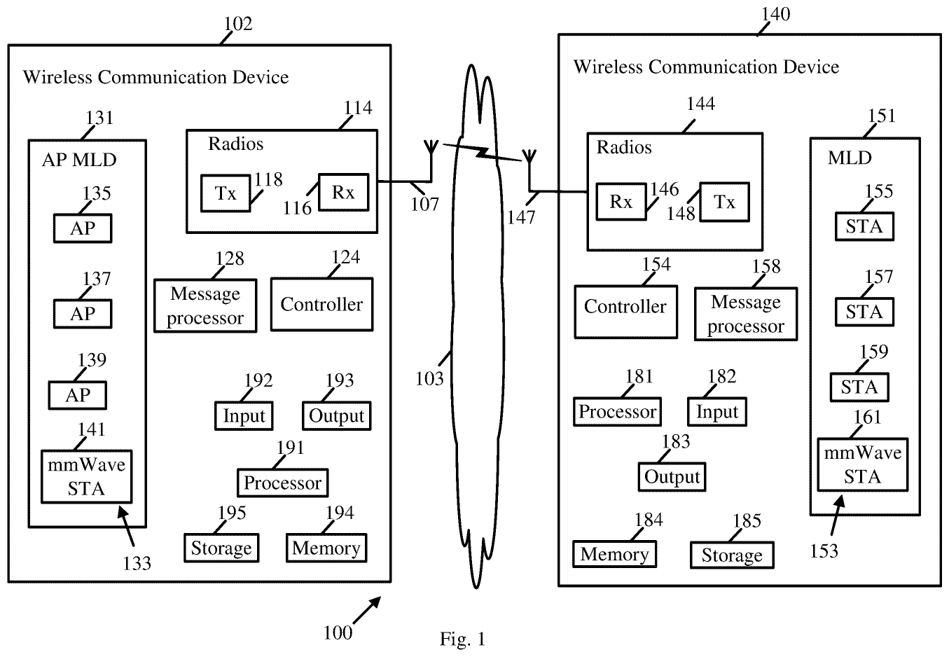

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 Ghz band, for example, 2.4 GHz band, a 5 GHz band, a 6 GHz band, and/or any other sub-10 GHz band; and/or an mmWave band, e.g., a 45 Ghz band, a 60 Ghz band, and/or any other mmWave band; and/or any other band, e.g., a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include one or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102 and/or device 140 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102, and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, an IEEE 802.11ay Specification and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 45 Ghz, for example, a 60 GHz band or any other mmWave band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

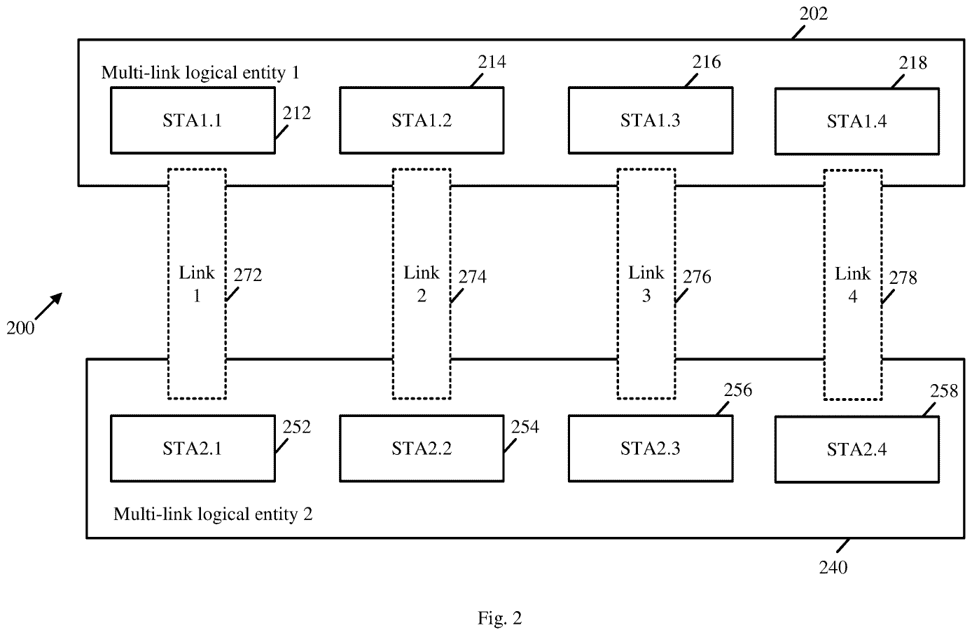

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

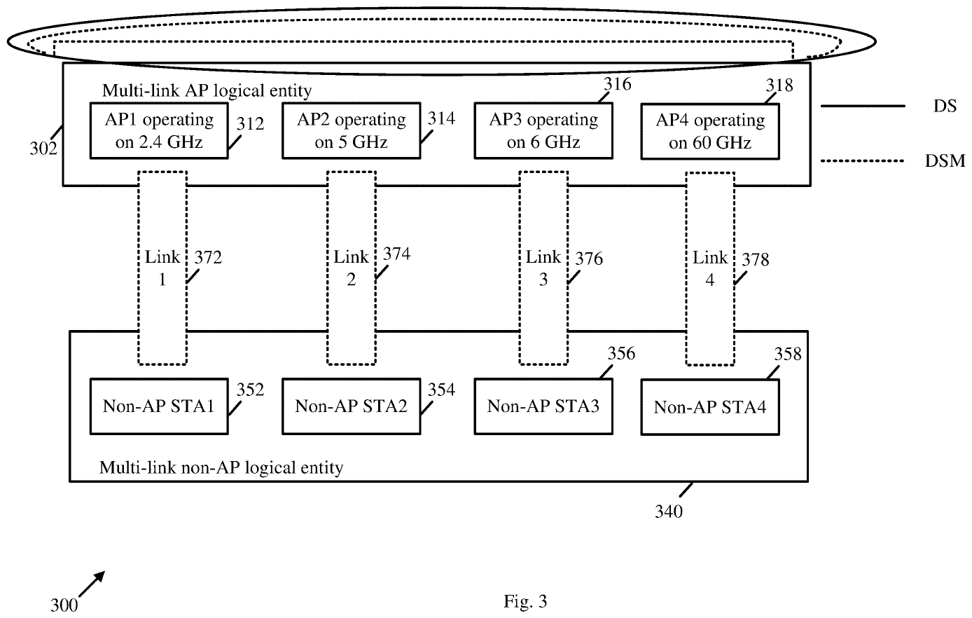

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to support a technical solution for communication between mmWave STAs, e.g., mmWave STA 141 and mmWave STA 161, over the mmWave frequency band, e.g., as described below.

In some demonstrative aspects, device 102 and/or device 140 may be configured to support a technical solution to utilize communications over the sub-10 GHz frequency band, for example, to assist one or more operations to be performed by the mmWave STAs, e.g., mmWave STA 141 and/or mmWave STA 161, over the mmWave frequency band, e.g., as described below.

In some demonstrative aspects, device 102 and/or device 140 may be configured to support a technical solution to utilize communications over the sub-10 GHz frequency band, for example, to assist a beamforming training procedure to be performed by the mmWave STAs, e.g., mmWave STA 141 and/or mmWave STA 161, over the mmWave frequency band, e.g., as described below.

In some demonstrative aspects, device 102 and/or device 140 may be configured to provide a technical solution to support mmWave operation, e.g., operation at the 60 GHz band, together with, and/or as part of, a sub-10 Ghz functionality, for example, of a mainstream Wi-Fi protocol, e.g., as described below.

In some demonstrative aspects, device 102 and/or device 140 may be configured to support a technical solution, which may be based on and/or may utilize cost reduction of a wireless communication architecture, which may allow to reuse at least some components of, e.g., as much as possible of, the same baseband, for communications by both a sub-10 GHz radio, e.g., a regular Wi-Fi radio, and a mmWave radio, e.g., a 60 GHz radio.

In some demonstrative aspects, device 102 and/or device 140 may be configured to support a technical solution, which may be based on and/or may utilize an enhanced throughput supported by mmWave techniques, e.g., compared to a sub-10 GHz band (lower band), which may have less potential for throughput enhancement.

In some demonstrative aspects, device 102 and/or device 140 may be configured to support a technical solution, which may be based on, and/or may utilize, a multi-link framework, for example, according to an MLD architecture, e.g., as described above.

In some demonstrative aspects, device 102 and/or device 140 may be configured to utilize the multi-link framework, for example, to improve operation on multiple links. In one example, the multi-link framework may be utilized to allow compensating for a fragility of an mmWave link, e.g., a 60 GHz link, for example, through a fallback to the sub-10 GHz band (lower band) operation.

In some demonstrative aspects, device 102 and/or device 140 may be configured to support a technical solution to utilize a beamforming (BF) training procedure, which may allow two or more STAs to train their antennas, for example, to determine the best sector to use to point in the direction of each other, for example, on transmit and/or receive directions, e.g., as described below.

In some demonstrative aspects, the beamforming training procedure may include a sector sweep by an initiator device to transmit training symbols and/or a training frame multiple times, for example, using different sectors, e.g., as described below.

In some demonstrative aspects, a receiver device (responder) may perform a receive sector sweep procedure, for example, during the sector sweep of the initiator device, e.g., as described below.

In other aspects, the receiver device may operate at an omni-receive mode to receive training frames from the initiator device.

In some demonstrative aspects, the receiver device may measure one or more values, e.g., a Received Signal Strength Indicator (RSSI), based on training frames that the receive device is capable of receiving from the initiator device.

In some demonstrative aspects, device 102 and/or device 140 may be configured to support a technical solution to perform beamforming training, e.g., the beamforming training procedure, over an mmWave wireless communication channel assisted by communications over a sub-10 GHz wireless communication channel, e.g., as described below.

In some demonstrative aspects, device 102 and/or device 140 may be configured to perform one or more operations of a procedure (also referred to as “sub-10 Ghz assisted procedure”), which may make use of an existing sub-10 Ghz link, e.g., a sub-7 GHz link, between two STAs that intend to establish an mmWave link, e.g., a 60 GHz link, to exchange discovery and/or beamforming training-related information, e.g., as described below.

In some demonstrative aspects, the sub-10 Ghz assisted procedure may be configured for implementation by a first STA, e.g., a STA implemented by device 102, and a second STA, e.g., a STA implemented by device 140, to perform discovery and/or initial beamforming training in the mmWave band, e.g., the 60 GHz band, for example, by exchanging related information on an existing sub-10 Ghz link, e.g., a sub-7 GHz link, as described below.

In some demonstrative aspects, the sub-10 Ghz assisted procedure may be configured for implementation by two STAs that have a sub-7 GHz link established to perform 60 GHz discovery and/or initial beamforming, e.g., as described below.

In some demonstrative aspects, device 102 and/or device 140 may be configured to implement a sub-10 Ghz assisted beamforming procedure, which may be configured to provide a technical solution to support a simple design and/or to reuse encoding from a sub-10 GHz band, for example, a lower band, e.g., as described below.

In some demonstrative aspects, device 102 and/or device 140 may be configured to perform one or more operations and/or communications of according to a beamforming procedure over a 60 GHz channel, e.g., as described below.

In some demonstrative aspects, the beamforming procedure may include an antenna sector training procedure, which may be configured to support “closing” a link between device 102 and device 140 to communicate over the 60 GHz channel.

In some demonstrative aspects, the antenna sector training may include an antenna sector steering using an antenna array. For example, an antenna array on an AP side, e.g., an initiator device, may include a relatively large number of antenna elements, for example, up to 32/64 antenna elements or any other number of antenna elements. For example, an antenna array on a STA side, e.g., a receiver device, may include a plurality of antenna elements, for example, at least 4 antenna elements or any other number of antenna elements.

In some demonstrative aspects, in some implementations, for example, in accordance with an IEEE 802.11ad/ay Specification, the antenna sector training may include a full antenna sector sweep. For example, during the full antenna sector sweep, both sides of a link, e.g., the AP side and/or the STA side, may provide receiver feedback on the best sector, for example, as a transmitter side steps through each sector in a scripted method.

In some demonstrative aspects, in some use cases, scenarios and/or implementations, there may be a need to address one or more technical issues of the full antenna sector sweep. For example, antennas may provide a relatively high gain, which may be needed due to range restrictions incurred at the 60 GHz band, for example, compared to that of the sub 7 GHz band. As a result, closing a link between two STAs over the mmWave band may be rather challenging, for example, especially when performing the full antenna sector sweep.

In some demonstrative aspects, a special PHY mode, e.g., a Control PHY mode, e.g., in accordance with to the IEEE 802.11ad/ay Specifications, may be implemented in order to perform acquisition and/or initial connection between the transmitter and the receiver sides. For example, an omni transmission may be used, e.g., to aid in the acquisition.

In some demonstrative aspects, device 102 and/or device 140 may be configured to implement a beamforming procedure, which may be configured to support a technical solution for beamforming training, for example, even without requiring a special PHY mode, e.g., for example, even without using the special control PHY mode, e.g., as described below.

In some demonstrative aspects, device 102 and/or device 140 may be configured to implement a beamforming procedure, which may be configured to utilize a beamforming sequence, which may be configured to support an initial beamforming training, e.g., even without using a control PHY and/or even for large antenna arrays, e.g., as described below.

In some demonstrative aspects, the beamforming procedure may be configured to utilize triggering and/or coordination, for example, over the sub-10 GHz band, for example, to trigger and/or coordinate the beamforming training over the mmWave band, e.g., as described below.

In some demonstrative aspects, a STA implemented by device 140 and/or a STA implemented by device 102 may be configured to operate over a mmWave band, e.g., a 60 GHz band, for example, according to an MLD mechanism. For example, a 60 GHz STA/AP may be implemented by a non-AP/AP MLD with at least another STA/AP operating in the sub-10 GHz band, e.g., over one or more of the 2.4/5/6 GHz bands, as described above.

In some demonstrative aspects, device 102 and/or device 140 may be configured to communicate and/or exchange over the sub-10 GHz assistance information, which may be configured to support reducing time of the beamforming training procedure and/or enhancing a mmWave link between device 102 and/or device 140. For example, device 102 and device 140 may establish an initial link in the sub-7 GHz band, which may be used to communicate the assistance information, for example, before establishing the mmWave link between device 102 and device 140.

In some demonstrative aspects, the assistance information may include information corresponding to the initial link over the sub-10 Ghz band, e.g., as described below.

In some demonstrative aspects, the assistance information may be configured to aid the devices in the antenna sector steering for example, with a prior knowledge of the link between device 102 and device 140, e.g., as described below.

In some demonstrative aspects, the assistance information may be configured to provide a technical solution to support beamforming training between two devices, e.g., device 102 and/or device 140, for example, using a sector sweep over a reduced number of sectors, for example, by performing a sector sweep over some sectors and avoiding a sector sweep of one or more other sectors, e.g., described below.

In some demonstrative aspects, the assistance information may be configured to provide a technical solution to support beamforming training between two devices, e.g., device 102 and/or device 140, for example, using a relatively efficient and/or quick sector sweep, for example, over one or more selected and/or identified sectors, e.g., as described below.

For example, a beamforming training procedure may be very long and/or inefficient, for example, if the beamforming procedure requires that two STAs perform a full antenna sector sweep, e.g., to test all sectors in all directions on a transmitter side and all sectors in all directions on a receiver side.

In some demonstrative aspects, device 102 and/or device 140 may be configured to utilize BF-assistance information, which may be communicated between device 102 and device 140 over the sub-10 Ghz band, for example, before a sector sweep over the mmWave band, e.g., as described below.

In some demonstrative aspects, the BF-assistance information may be configured to provide a technical solution to support acceleration of the sector sweep training phase, for example, by limiting a number of sectors to test, e.g., as described below.

In some demonstrative aspects, the BF-assistance information may be configured to provide a BF training transmitter side, e.g., device 102, with information regarding a location and/or direction at which a receiver side, e.g., device 140, is positioned, e.g., as described below.

In some demonstrative aspects, the BF-assistance information may be configured to provide a technical solution to support the BF training transmitter side, e.g., device 102, in a decision to test only the some sectors, e.g., sectors that are pointing in the direction of the receiver device, e.g., as described below.

In some demonstrative aspects, the BF-assistance information may be configured to provide a BF training receiver side, e.g., device 140, with information regarding a location and/or direction at which a transmitter side, e.g., device 140, is positioned, e.g., as described below.

In some demonstrative aspects, the BF-assistance information may be configured to provide a technical solution to support the BF training receiver side, e.g., device 140, in a decision to test only the some sectors, e.g., sectors that are pointing in the direction of the transmitter device, e.g., as described below.

In some demonstrative aspects, device 102 and/or device 140 may be configured to exchange the BF-assistance information over the sub-10 GHz band, e.g., the lower band, for example, before performing a BF training procedure over the mmWave band, e.g., as described below.

In some demonstrative aspects, device 102 and/or device 140 may be configured to generate, transmit, receive and/or process one or more messages over the sub-10 GHz frequency band including BF assistance information configured to provide localization information to support BF raining over the mmWave frequency band, e.g., as described below.

In some demonstrative aspects, a device, e.g., device 102 and/or device 140, may be configured to generate and/or transmit over the sub-10 GHz frequency band one or more frames including BF assistance information including localization information corresponding to a location of the device, e.g., as described below.

In some demonstrative aspects, the localization information may be based on GPS information acquired by the device, e.g., from one or more GPS receivers of the device.

In some demonstrative aspects, the localization information may be based on information from a location service provided by a network, e.g., an AP network, a cellular network, and/or any other network.

In some demonstrative aspects, a non-AP device, e.g., a non-AP device implemented by device 140, may be configured to transmit to an AP device, e.g., an AP device implemented by device 102, a frame over the sub-10 Ghz frequency band, for example, prior to performing a BF procedure between the non-AP device and the AP device over the mmWave frequency band. For example, the frame from the non-Ap device may include BF-assistance information including localization information corresponding to the non-AP device.

In some demonstrative aspects, an AP device, e.g., an AP device implemented by device 102, may be configured to transmit to a non-AP device, e.g., a non-AP device implemented by device 140, a frame over the sub-10 Ghz frequency band, for example, prior to performing a BF procedure between the non-AP device and the AP device over the mmWave frequency band. For example, the frame from the AP device may include BF-assistance information including localization information corresponding to the AP device.

In some demonstrative aspects, the AP device and the non-Ap device may be configured to exchange one or more frames including the localization information corresponding to the AP device and/or the localization information corresponding to the non-AP device, for example, during an association process and/or as part of any other procedure and/or frame exchange over the sub-10 GHz frequency band.

In one example, the non-AP device, e.g., the non-AP device implemented by device 140, may be configured to transmit to the AP device an association request frame including the localization information corresponding to the non-AP device, e.g., over the sub-GHz frequency band.

In one example, the AP device, e.g., the AP device implemented by device 102, may be configured to transmit to the non-AP device an association response frame including the localization information corresponding to the AP device, e.g., over the sub-GHz frequency band.

In another example, the AP device and/or the non-AP device may be configured to transmit the localization information as part of a dedicated frame, which may be sent for example, post-association. For example, the dedicated frame may include the localization information in an encrypted and/or protected manner. For example, the dedicated frame may be encrypted to protect the localization information, which be sensitive.

In some demonstrative aspects, the AP device and/or the non-AP device may be configured to transmit the localization information as part of an exchange of a request frame and a response frame between two peer devices.

In one example, a first peer, e.g., the AP device, may transmit to a second peer, e.g., the non-AP device, a request frame configured to request the localization information corresponding to the second peer. For example, the second peer, e.g., the non-AP device, may transmit to the first peer, e.g., the AP device, a response frame including the localization information corresponding to the second peer.

In another example, a first peer, e.g., the non-AP device, may transmit to a second peer, e.g., the AP device, a request frame configured to request the localization information corresponding to the second peer. For example, the second peer, e.g., the AP device, may transmit to the first peer, e.g., the non-AP device, a response frame including the localization information corresponding to the second peer.

In other aspects, any other frames may be utilized to communicate the localization information corresponding to the AP device and/or the localization information corresponding to the non-AP device.

In some demonstrative aspects, a device, e.g., device 102 and/or device 140, may be configured to generate and/or transmit over the sub-10 GHz frequency band one or more frames including BF assistance information including channel sounding information corresponding to a channel over the sub-10 GHz frequency band, e.g., as described below.

In some demonstrative aspects, the channel sounding information may be utilized as the BF assistance information in addition to, or instead of the localization information.

In some demonstrative aspects, channel sounding information may be acquired by a device, e.g. device 102 and/or device 140, for example, according to a suitable channel sounding protocol, for example, based on measurements on one or more frames received by the device over the sub-10 GHz frequency band.

In some demonstrative aspects, channel sounding information may be acquired by a device, e.g. device 102 and/or device 140, for example, based on a channel estimation measurement on one or more frames, e.g., each frame or some frames, received by the device over the sub-10 GHz frequency band.

In some demonstrative aspects, a device, e.g. device 102 and/or device 140, may be configured to determine the channel sounding information to include information corresponding an mmWave channel over the mmWave frequency band, for example, based on measurements on one or more frames received by the device over the sub-10 GHz frequency band, e.g., as described below.

In some demonstrative aspects, a device, e.g. device 102 and/or device 140, may be configured to determine the channel sounding information, for example, according to a sounding protocol using a Sounding Announcement frame, followed by one or more Null data packets (NDPs) carrying one or more channel estimation training fields. For example, the device, e.g. device 102 and/or device 140, may be configured to transmit the channel sounding information in the form of a feedback frame, e.g., to a peer device, e.g., in a reverse direction.

In some demonstrative aspects, device 102 may be configured to determine whether an mmWave channel for BF training with device 140 is possibly, e.g., is likely, to be a Line of Sight (LoS) channel or a non-LoS channel, for example, based on channel sounding information of a channel sounding procedure performed over a sub-10 Ghz channel between device 102 and device 140.

In some demonstrative aspects, device 140 may be configured to determine whether an mmWave channel for BF training with device 102 is possibly, e.g., is likely, to be an LoS channel or a non-LoS channel, for example, based on channel sounding information of a channel sounding procedure performed over a sub-10 Ghz channel between device 140 and device 102.

In some demonstrative aspects, device 140 may be configured to determine an Angle of Arrival (AoA) of a main path of a signal between device 140 and device 102, for example, based on one or more frames, e.g., NDPs and/or any other frames, received via a plurality of different receive antennas of device 140.

In some demonstrative aspects, device 102 may be configured to determine an AoA of a main path of a signal between device 102 and device 140, for example, based on one or more frames, e.g., NDPs and/or any other frames, received via a plurality of different receive antennas of device 102.

In some demonstrative aspects, the AoA may be determined, for example, based on a comparison between the differences in phase, e.g., between signals received at different receive antennas.

In some demonstrative aspects, a first device may be configured to determine a relative location and/or directionality between the first device and a second device, for example, based on the localization information of the first device, the localization information of the second device, and/or the channel sounding information corresponding to a channel between the first device and the second device, e.g., as described below.

In some demonstrative aspects, the first device may be configured to determine one or more selected sectors from a plurality of sectors of the device, for example, based on the determined relative location and/or directionality between the first device and the second device, e.g., as described below.

In some demonstrative aspects, the first device may be configured to use the one or more selected sectors to perform BF training between the first device and the second device, e.g., as described below.

In some demonstrative aspects, the first device may be configured to select not to use one or more other sectors, e.g., which are not included in the selected sectors, to perform BF training between the first device and the second device, e.g., as described below.

For example, the first device may determine a direction of arrival from the second device, and the first device may determine that there is a good confidence that this direction of arrival is a line of sight direction. For example, the first device may determine which sector at 60 GHz corresponds to which direction. For example, the first device may select to use one or more sectors, e.g., only the sectors, that will be pointing in the determined direction, e.g., as described below.

In some demonstrative aspects, device 102 may be configured to determine a relative location and/or directionality between device 102 and device 140, for example, based on the localization information of device 102, the localization information of device 140, and/or the channel sounding information corresponding to a channel between device 102 and 140. For example, device 102 may be configured to determine one or more selected sectors from a plurality of sectors of device 102, for example, based on the determined relative location and/or directionality between the device 102 and the device 140. For example, device 102 may be configured to use the one or more selected sectors to perform BF training between device 102 and device 140. For example, device 102 may be configured to select not to use one or more other sectors, e.g., which are not included in the selected sectors, to perform BF training between device 102 and device 140.

In some demonstrative aspects, device 140 may be configured to determine a relative location and/or directionality between device 140 and device 102, for example, based on the localization information of device 140, the localization information of device 102, and/or the channel sounding information corresponding to a channel between device 140 and 102. For example, device 140 may be configured to determine one or more selected sectors from a plurality of sectors of device 140, for example, based on the determined relative location and/or directionality between the device 140 and the device 102. For example, device 140 may be configured to use the one or more selected sectors to perform BF training between device 140 and device 102. For example, device 140 may be configured to select not to use one or more other sectors, e.g., which are not included in the selected sectors, to perform BF training between device 140 and device 102.

In some demonstrative aspects, the channel sounding information may usually be derived according to a channel sounding protocol, for example, by a receiver/responder side of the BF training, e.g., by a non-AP device.

In some demonstrative aspects, device 102 and/or device 140 may be configured to utilize an initiator channel sounding mechanism to support an initiator to request a responder to transmit frames that will allow the initiator to derive such channel sounding information.

In some demonstrative aspects, for example, the initiator may transmit a frame that triggers the responder to transmit a sounding frame, e.g., an NDP frame, and the initiator may use the NDP frame, for example, to determine channel sounding information.

In some demonstrative aspects, device 102 and/or device 140 may be configured to utilize the BF-assistance information, for example, to perform BF training over the mmWave band, for example, while using a reduced number of trained sectors, which may be identified and/or selected based on the BF-assistance information, e.g., as described below.

In some demonstrative aspects, device 102 and/or device 140 may be configured to communicate assistance information in the sub-10 GHz band, e.g., in the lower band, for example, to indicate to one another a number of sectors to be trained on their side, e.g., as described below.

For example, device 102 may be configured to transmit to device 140 a frame over the sub-10 Ghz frequency band including BF-assistance information to indicate a number of sectors selected by device 102 for BF training with device 140, e.g., as descried below.

For example, device 140 may be configured to transmit to device 102 a frame over the sub-10 Ghz frequency band including BF-assistance information to indicate a number of sectors selected by device 140 for BF training with device 102, e.g., as descried below.

In some demonstrative aspects, device 102 and/or device 140 may perform a BF training sequence over the mmWave frequency band, which may be configured, for example, based on the BF-assistance information exchanged between devices 102 and/or 140 over the sub-10 Ghz frequency band, e.g., as described below.

In some demonstrative aspects, device 102 and/or device 140 may be configured to generate, process and/or communicate one or more frames including BF assistance information, e.g., as described below.

In some demonstrative aspects, a wireless communication device, e.g., device 102 and/or device 140, may be configured to transmit a frame including BF assistance information from a sub-10 GHz STA of the wireless communication device over a sub-10 GHz wireless communication channel, e.g., as described below.

In some demonstrative aspects, the BF assistance information may correspond to an mmWave STA of the wireless communication device, e.g., as described below.

In some demonstrative aspects, the BF assistance information may include orientation-based information corresponding to the mmWave STA, e.g., as described below.

In some demonstrative aspects, the orientation-based information corresponding to the mmWave STA may be based on an orientation of the mmWave STA, e.g., as described below.

For example, controller 124 may be configured to control device 102 to transmit a frame from a sub-10 GHz STA of device 102, e.g., STA 135, over the sub-10 GHz wireless communication channel. The frame may include the BF assistance information corresponding to an mmWave STA implemented by device 102, e.g., mmWave STA 141.

For example, controller 154 may be configured to control device 140 to transmit a frame from a sub-10 GHz STA of device 140, e.g., STA 155, over the sub-10 GHz wireless communication channel. The frame may include the BF assistance information corresponding to an mmWave STA implemented by device 140, e.g., mmWave STA 161.

In some demonstrative aspects, the wireless communication device, e.g., device 102 and/or device 140, may be configured to communicate by the mmWave STA of the wireless communication device one or more BF training frames over an mmWave wireless communication channel, e.g., as described below.

For example, controller 124 may be configured to control device 102 to communicate by the mmWave STA 141 of device 102 one or more BF training frames over the mmWave wireless communication channel.

For example, controller 154 may be configured to control device 140 to communicate by the mmWave STA 161 of device 140 one or more BF training frames over the mmWave wireless communication channel.

In some demonstrative aspects, the wireless communication device, e.g., device 102 and/or device 140, may include an MLD, e.g., as described above.

In some demonstrative aspects, the sub-10 GHz wireless communication channel may include a sub-7 GHz channel, for example, a 2.4 GHz channel, a 5 GHz channel, a 6 GHz channel, and/or any other sub-10 GHz wireless communication channel, e.g., as described above.

In some demonstrative aspects, the mmWave wireless communication channel may include a 60 GHz channel.

In other aspects, the mmWave wireless communication channel may include any other mmWave channel.

In some demonstrative aspects, the wireless communication device transmitting the frame may include an AP device, e.g., as described below.

In some demonstrative aspects, the sub-10 GHz STA of the wireless communication device may include a sub-10 GHz AP, e.g., as described below.

In some demonstrative aspects, the mmWave STA of the wireless communication device may include an mmWave AP, e.g., as described below.

For example, device 102 may include an AP device including a sub-10 GHz AP, e.g., sub-10 GHz AP 135, and an mmWave AP, e.g., mmWave AP 141.

In some demonstrative aspects, the wireless communication device transmitting the frame may include a non-AP device, e.g., as described below.

In some demonstrative aspects, the sub-10 GHz STA of the wireless communication device may include a sub-10 GHz non-AP STA, e.g., as described below.

In some demonstrative aspects, the mmWave STA of the wireless communication device may include an mmWave non-AP STA, e.g., as described below.

For example, device 140 may include a non-AP device including a sub-10 GHz non-AP STA, e.g., sub-10 GHz non-AP STA 155, and an mmWave non-AP STA, e.g., mmWave STA 161.

In some demonstrative aspects, the orientation-based information corresponding to the mmWave STA of the wireless communication device transmitting the frame may include location information corresponding to a location of the wireless communication device transmitting the frame, e.g., as described below.

For example, the orientation-based information corresponding to the mmWave STA 141 of device 102 may include location information corresponding to a location of device 102.

For example, the orientation-based information corresponding to the mmWave STA 161 of device 140 may include location information corresponding to a location of device 140.

In some demonstrative aspects, the orientation-based information corresponding to the mmWave STA of the wireless communication device transmitting the frame may include relative directionality information corresponding to a directionality of the mmWave STA relative to another mmWave STA of another wireless communication device, e.g., as described below.

For example, the orientation-based information corresponding to the mmWave STA 141 of device 102 may include relative directionality information corresponding to a directionality of the mmWave STA 141 relative to another mmWave STA of another wireless communication device, e.g., the mmWave STA 161 of device 140.

For example, the orientation-based information corresponding to the mmWave STA 161 of device 140 may include relative directionality information corresponding to a directionality of the mmWave STA 161 relative to another mmWave STA of another wireless communication device, e.g., the mmWave STA 141 of device 102.

In some demonstrative aspects, the orientation-based information corresponding to the mmWave STA of the wireless communication device transmitting the frame may include Line-of-Sight (LoS) information, for example, based on whether a LoS exists between the mmWave STA and another mmWave STA of another wireless communication device, e.g., as described below.

For example, the orientation-based information corresponding to the mmWave STA 141 of device 102 may include LoS information, for example, based on whether a LoS exists between the mmWave STA 141 and another mmWave STA of another wireless communication device, e.g., the mmWave STA 161 of device 140.

For example, the orientation-based information corresponding to the mmWave STA 161 of device 140 may include LoS information, for example, based on whether a LoS exists between the mmWave STA 161 and another mmWave STA of another wireless communication device, e.g., the mmWave STA 141 of device 102.

In some demonstrative aspects, the orientation-based information corresponding to the mmWave STA of the wireless communication device transmitting the frame may include channel sounding information based, for example, on a propagation channel between the sub-10 GHz STA of the wireless communication device and another sub-10 GHz STA of another wireless communication device, e.g., as described below.

For example, the orientation-based information corresponding to the mmWave STA 141 of device 102 may include channel sounding information based, for example, on a propagation channel between the sub-10 GHz STA of device 102 and another sub-10 GHz STA of another wireless communication device, e.g., the sub-10 GHz STA of device 140.

For example, the orientation-based information corresponding to the mmWave STA 161 of device 140 may include channel sounding information based, for example, on a propagation channel between the sub-10 GHz STA of device 140 and another sub-10 GHz STA of another wireless communication device, e.g., the sub-10 GHz STA of device 102.

In some demonstrative aspects, the frame transmitted from the sub-10 GHz STA of the wireless communication device may include a BF setup request, for example, to setup a BF procedure over the mmWave wireless communication channel, e.g., as described below.

In some demonstrative aspects, the frame transmitted from the sub-10 GHz STA of the wireless communication device may include a BF setup response, for example, to setup the BF procedure over the mmWave wireless communication channel, e.g., as described below.

For example, sub-10 GHz STA 155 of device 140 may be configured to transmit a BF setup request to device 102, for example, to setup with the device 102 a BF procedure over the mmWave wireless communication channel. For example, the BF setup request may include the orientation-based information corresponding to the mmWave STA of device 140.

For example, sub-10 GHz AP 135 of device 102 may be configured to transmit a BF setup response to device 140, for example, to setup with the device 140 the BF procedure over the mmWave wireless communication channel. For example, the BF setup request may include the orientation-based information corresponding to the mmWave STA of device 102.

In some demonstrative aspects, the frame transmitted from the sub-10 GHz STA of the wireless communication device may include an association request, for example, to setup an association between the sub-10 GHz STA and another sub-10 GHz STA of another wireless communication device, e.g., as described below.

In some demonstrative aspects, the frame transmitted from the sub-10 GHz STA of the wireless communication device may include an association response, for example, to setup the association between the sub-10 GHz STA and another sub-10 GHz STA of another wireless communication device, e.g., as described below.

For example, sub-10 GHz STA 155 of device 140 may be configured to transmit an association request to device 102, for example, to setup an association between the sub-10 GHz STA 155 and a sub-10 GHz STA of device 102. For example, the association request may include the orientation-based information corresponding to the mmWave STA of device 140.

For example, sub-10 GHz STA 135 of device 102 may be configured to transmit an association response to device 140, for example, to setup the association between the sub-10 GHz STA 135 and sub-10 GHz STA 155 of device 140. For example, the association response may include the orientation-based information corresponding to the mmWave STA of device 102.

In some demonstrative aspects, the wireless communication device, e.g., device 102 and/or device 140, may be configured to act as a first device including a first sub-10 GHz STA and a first mmWave STA, to process a received frame, for example, received by the first sub-10 GHz STA over the a sub-10 GHz wireless communication channel, e.g., as described below.

In some demonstrative aspects, the received frame may be from a second sub-10 GHz STA of a second device, e.g., as described below.

In some demonstrative aspects, the received frame may include BF assistance information corresponding to a second mmWave STA of the second device, e.g., as described below.

In some demonstrative aspects, the wireless communication device, e.g., device 102 and/or device 140, may be configured to communicate the BF training frames by the first mmWave STA, for example, based on the BF assistance information corresponding to the second mmWave STA of the second device, e.g., as described below.

For example, controller 124 may be configured to cause device 102 to act as the first device including the first sub-10 GHz STA and the first mmWave STA to process the received frame from the second device, e.g., device 140.

For example, controller 154 may be configured to cause device 140 to act as the first device including the first sub-10 GHz STA and the first mmWave STA to process the received frame from the second device, e.g., device 102.

In some demonstrative aspects, the BF assistance information corresponding to the second mmWave STA may include orientation-based information corresponding to the second mmWave STA, e.g., as described below.

In some demonstrative aspects, the orientation-based information corresponding to the second mmWave STA may be based on an orientation of the second mmWave STA, e.g., as described below.

In some demonstrative aspects, the orientation-based information corresponding to the second mmWave STA may include location information corresponding to a location of the second device, e.g., as described below.

For example, device 102 may receive from device 140 the orientation-based information including the location information corresponding to the mmWave STA of device 140.

For example, device 140 may receive from device 102 the orientation-based information including the location information corresponding to the mmWave STA of device 102.

In some demonstrative aspects, the orientation-based information corresponding to the second mmWave STA may include relative directionality information, for example, based on a directionality of the second mmWave STA relative to the first mmWave STA, e.g., as described below.

For example, device 102 may receive from device 140 the orientation-based information including the relative directionality information based on the directionality of the mmWave STA of device 140 relative to the mmWave of device 102.

For example, device 140 may receive from device 102 the orientation-based information including the relative directionality information based on the directionality of the mmWave STA of device 102 relative to the mmWave of device 140.

In some demonstrative aspects, the orientation-based information corresponding to the second mmWave STA may include LoS information, for example, based on whether a LOS exists between the second mmWave STA and the first mmWave STA, e.g., as described below.

For example, device 102 may receive from device 140 the orientation-based information including the LoS information based on whether a LoS exists between the mmWave of device 140 and the mmWave STA of device 102.

For example, device 140 may receive from device 102 the orientation-based information including the LoS information based on whether a LoS exists between the mmWave of device 102 and the mmWave STA of device 140.

In some demonstrative aspects, the orientation-based information corresponding to the second mmWave STA may include channel sounding information based, for example, on a propagation channel between the first sub-10 GHz STA of the first device and the second sub-10 GHz STA of the second device, e.g., as described below.

For example, device 102 may receive from device 140 the orientation-based information including the channel sounding information based on the propagation channel between the sub-10 GHz STA of device 102 and the sub-10 GHz STA of device 140.

For example, device 140 may receive from device 102 the orientation-based information including the channel sounding information based on the propagation channel between the sub-10 GHz STA of device 140 and the sub-10 GHz of device 102.

In some demonstrative aspects, the wireless communication device, e.g., device 102 and/or device 140, may be configured to determine one or more selected antenna sectors of the first mmWave STA of the first device, for example, based on the orientation-based information corresponding to the second mmWave STA of the second device, e.g., as described below.

For example, controller 124 may be configured to cause device 102 to determine the one or more selected antenna sectors of the mmWave STA of device 102, for example, based on the orientation-based information corresponding to the mmWave STA of device 140.

For example, controller 154 may be configured to cause device 140 to determine the one or more selected antenna sectors of the mmWave STA of device 140, for example, based on the orientation-based information corresponding to the mmWave STA of device 102.

In some demonstrative aspects, the wireless communication device, e.g., device 102 and/or device 140, may be configured to communicate the BF training frames via the one or more selected antenna sectors of the first mmWave STA, e.g., as described below.

For example, controller 124 may be configured to cause device 102 to communicate the BF training frames with device 140, for example, via the one or more selected antenna sectors of the mmWave STA of device 102.

For example, controller 154 may be configured to cause device 140 to communicate the BF training frames with device 102, for example, via the one or more selected antenna sectors of the mmWave STA of device 140.

In some demonstrative aspects, the wireless communication device, e.g., device 102 and/or device 140, may be configured to determine a sector size of the one or more selected antenna sectors of the first mmWave STA of the first device, for example, based on the orientation-based information corresponding to the second mmWave STA of the second device, e.g., as described below.

For example, controller 124 may be configured to cause device 102 to determine a sector size of the one or more selected antenna sectors of the mmWave STA of device 102, for example, based on the orientation-based information corresponding to the mmWave STA of device 140.

For example, controller 154 may be configured to cause device 140 to determine a sector size of the one or more selected antenna sectors of the mmWave STA of device 140, for example, based on the orientation-based information corresponding to the mmWave STA of device 102.

In some demonstrative aspects, the first sub-10 GHz STA of the first device may be configured to transmit to the second sub-10 GHz STA of the second device a message including sector information corresponding to the one or more selected antenna sectors of the first mmWave STA of the first device, e.g., as described below.

In some demonstrative aspects, the sector information may include a count of the one or more selected antenna sectors of the first mmWave STA, e.g., as described below.

For example, controller 124 may be configured to cause device 102 to transmit from the sub-10 GHz STA of device 102 to the sub-10 GHz STA of device 140 a message including sector information corresponding to the one or more selected antenna sectors of the sub-10 GHz STA of device 102. For example, the sector information transmitted from the sub-10 GHz STA of device 102 to the sub-10 GHz STA of device 140 may include a count of the one or more selected antenna sectors of the mmWave STA of device 102.

For example, controller 154 may be configured to cause device 140 to transmit from the sub-10 GHz STA of device 140 to the sub-10 GHz STA of device 102 a message including sector information corresponding to the one or more selected antenna sectors of the sub-10 GHz STA of device 140. For example, the sector information transmitted from the sub-10 GHz STA of device 140 to the sub-10 GHz STA of device 102 may include a count of the one or more selected antenna sectors of the mmWave STA of device 140.

In some demonstrative aspects, the wireless communication device, e.g., device 102 and/or device 140, may be configured to determine one or more excluded antenna sectors of the first mmWave STA of the first device, for example, based on the orientation-based information corresponding to the second mmWave STA of the second device, e.g., as described below.

In some demonstrative aspects, the wireless communication device, e.g., device 102 and/or device 140, may be configured to communicate the BF training frames, for example, according to a sector sweep of the first mmWave STA excluding the one or more excluded antenna sectors of the first mmWave STA, e.g., as described below.

For example, controller 124 may be configured to cause device 102 to determine one or more excluded antenna sectors of the mmWave STA of device 102, for example, based on the orientation-based information corresponding to the mmWave STA of device 140.

For example, controller 124 may be configured to cause device 102 to transmit the BF training frames to device 140, for example, according to a sector sweep of the mmWave STA of device 102, e.g., excluding the one or more excluded antenna sectors of the mmWave STA of device 102.

For example, controller 154 may be configured to cause device 140 to determine one or more excluded antenna sectors of the mmWave STA of device 140 based on the orientation-based information corresponding to the mmWave STA of device 102.

For example, controller 154 may be configured to cause device 140 to transmit the BF training frames to device 102, for example, according to a sector sweep of the mmWave STA of device 140, e.g., excluding the one or more excluded antenna sectors of the mmWave STA of device 140.

In some demonstrative aspects, a wireless communication device, e.g., device 102 and/or device 140, may be configured to act as a first device of a BF training between a first mmWave STA of the first device and a second mmWave STA of a second device, e.g., as described above.

In some demonstrative aspects, the wireless communication device, e.g., device 102 and/or device 140, may be configured to identify a relative orientation of the first device relative to the second device, for example, based on a received frame from the second device, e.g., as described above.

In some demonstrative aspects, the received frame may be received at a first sub-10 GHz STA of the first device from a second sub-10 GHz STA of the second device over a sub-10 GHz wireless communication channel, e.g., as described above.

In some demonstrative aspects, the wireless communication device, e.g., device 102 and/or device 140, may be configured to determine one or more selected antenna sectors of the first mmWave STA of the first device, for example, based on the relative orientation of the first device relative to the second device, e.g., as described above.

In some demonstrative aspects, the wireless communication device, e.g., device 102 and/or device 140, may be configured to communicate BF training frames, for example, via the one or more selected antenna sectors of the first mmWave STA of the first device, e.g., as described above.

In some demonstrative aspects, the received frame may include BF assistance information corresponding to the second mmWave STA of the second device, e.g., as described above.

In some demonstrative aspects, the BF assistance information corresponding to the second mmWave STA may be configured to include orientation-based information corresponding to the second mmWave STA, e.g., as described above.

In some demonstrative aspects, the orientation-based information corresponding to the second mmWave STA may be based on an orientation of the second mmWave STA, e.g., as described above.

In some demonstrative aspects, the first sub-10 GHz STA of the first device may be configured to transmit a transmitted frame including BF assistance information corresponding to the first mmWave STA of the first device, e.g., as described above.

In some demonstrative aspects, the wireless communication device, e.g., device 102 and/or device 140, may be configured to receive the received frame including a channel sounding frame including one or more channel sounding sequences, e.g., as described above.

In some demonstrative aspects, the orientation-based information corresponding to the first mmWave STA of the first device may include channel sounding information, for example, based on a channel between the first mmWave STA of the first device and the second mmWave STA of the second device, e.g., as described above.

In some demonstrative aspects, the wireless communication device, e.g., device 102 and/or device 140, may be configured to determine a sector size of the one or more selected antenna sectors of the first mmWave STA, for example, based on the relative orientation of the first device relative to the second device, e.g., as described above.

In some demonstrative aspects, the first sub-10 GHz STA of the first device may be configured to transmit to the second sub-10 GHz STA of the second device a message including sector information corresponding to the one or more selected antenna sectors of the first mmWave STA of the first device, e.g., as described above.

In some demonstrative aspects, the sector information may include a count of the one or more selected antenna sectors of the first mmWave STA of the first device, e.g., as described above.

In some demonstrative aspects, the wireless communication device, e.g., device 102 and/or device 140, may be configured to determine one or more excluded antenna sectors of the first mmWave STA of the first device, for example, based on the relative orientation of the first device relative to the second device, e.g., as described above.

In some demonstrative aspects, the wireless communication device, e.g., device 102 and/or device 140, may be configured to communicate the BF training frames according to a sector sweep of the first mmWave STA of the first device, for example, excluding the one or more excluded antenna sectors of the first mmWave STA, e.g., as described above.

In one example, controller 124 may be configured to cause device 102 to act as the first device of a BF training with the second device, e.g., device 140.

For example, controller 124 may be configured to cause device 102 to receive at the sub-10 GHz STA of device 102 the received frame from the sub-10 GHz STA of device 140 over the sub-10 GHz wireless communication channel.

For example, controller 124 may be configured to cause device 102 to determine one or more selected antenna sectors of the mmWave STA of device 102, for example, based on the relative orientation of device 102 relative to device 140.

For example, controller 124 may be configured to cause device 102 to communicate BF training frames via the one or more selected antenna sectors of the mmWave STA of device 102.

In another example, controller 154 may be configured to cause device 140 to act as the first device of a BF training with the second device, e.g., device 102.

For example, controller 154 may be configured to cause device 140 to receive at the sub-10 GHz STA of device 140 the received frame from the sub-10 GHz STA of device 102 over the sub-10 GHz wireless communication channel.

For example, controller 154 may be configured to cause device 140 to determine one or more selected antenna sectors of the mmWave STA of device 140, for example, based on the relative orientation of device 140 relative to device 102.

For example, controller 154 may be configured to cause device 140 to communicate BF training frames via the one or more selected antenna sectors of the mmWave STA of device 140.

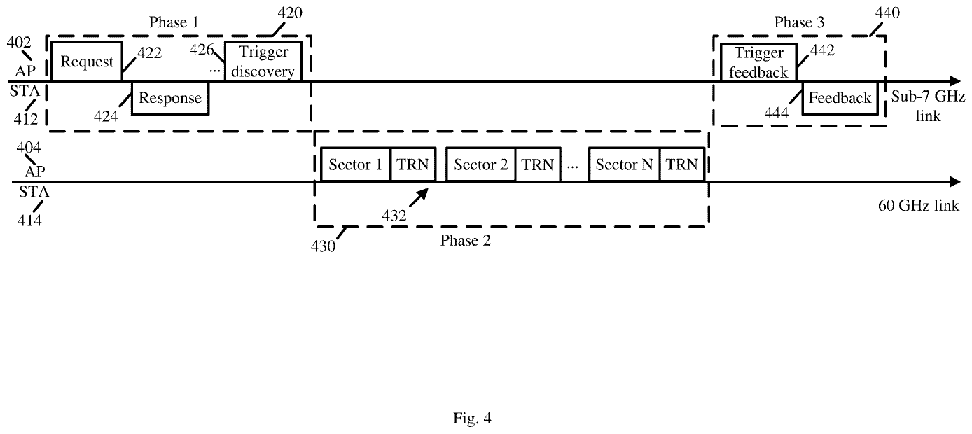

Reference is made to FIG. 4, which schematically illustrates a sector sweep procedure, in accordance with some demonstrative aspects.

In some demonstrative aspects, as shown in FIG. 4, one or more operations of the sector sweep procedure of FIG. 4 may be performed by a first device (initiator), for example, an AP device including a sub-10 Ghz AP 402 and an mmWave AP 404, and a second device (responder), for example, a non-AP device including a sub-10 Ghz non-AP STA 412 and an mmWave non-AP STA 414, e.g., as described below. For example, controller 124 (FIG. 1) may be configured to control, trigger, and/or cause the AP device implemented by device 102 (FIG. 1) to perform a role of, one or more operations of, and/or one or more functionalities of, the AP device including sub-10 Ghz AP 402 and mmWave AP 404; and/or controller 154 (FIG. 1) may be configured to control, trigger, and/or cause the non-AP device implemented by device 140 (FIG. 1) to perform a role of, one or more operations of, and/or one or more functionalities of, the non-AP device including sub-10 Ghz non-AP STA 412 and mmWave non-AP STA 414.

In some demonstrative aspects, as shown in FIG. 4, two STAs, e.g., the AP STA and the non-AP STA, that have a link established in a sub-7 GHz band may intend to establish a 60 GHz link as well.

In some demonstrative aspects, as shown in FIG. 4, the AP STA and the non-AP STA may perform one or more operations of a phase (“phase 1”) 420, which may be configured to setup, negotiate, and/or trigger 60 GHz discovery and/or initial beamforming, e.g., as described below.

In some demonstrative aspects, as shown in FIG. 4, a frame exchange, e.g., including a request frame 422 and a response frame 424, may be performed between the two STAs, during which capabilities and/or operating parameters related to 60 GHz operation may be exchanged and/or negotiated.

In some demonstrative aspects, as shown in FIG. 4, the start of the discovery and/or initial beamforming, e.g., in the 60 GHz band, may be “triggered” by the AP, e.g., using a trigger frame 426.

In some demonstrative aspects, as shown in FIG. 4, the initial frame exchange between the two STAs, e.g., the frames 422 and/or 424, may include 60 GHz-related capabilities and/or operating parameters that may determine the configuration of the PPDUs used for the sector sweep procedure, and/or an overall flow of the discovery and initial beamforming process that follows, e.g., as described below.

For example, the sub-10 GHz AP 402 may communicate with the sub-10 GHz non-AP STA 412 BF assistance information including 60 GHz-related capabilities and/or operating parameters, for example via the exchange of frames 422 and/or 424. For example, as shown in FIG. 4, the, 60 GHz-related capabilities and/or operating parameters may be exchanged and/or negotiated between the sub-10 GHz AP 402 and the sub-10 GHz non-AP STA 412 using the sub-10 Ghz band, e.g., a lower band, for example, before antenna steering, e.g., before any operation of antenna steering, is initiated on a 60 GHz channel.

In some demonstrative aspects, the initial frame exchange between the two STAs, e.g., the frames 422 and/or 424, may be configured to indicate, signal, set and/or negotiate one or more of the following parameters (“BF-assistance parameters”) to configure the sector sweep procedure:
The start time of a frame exchange during the sector sweep procedure over the 60 GHz channel. For example, as shown in FIG. 4, trigger frame 426 may be transmitted in the sub-7 GHz channel, for example, as an implied trigger in the 60 GHz channel;
One or more parameters (“sector-sweep setup parameters”) corresponding to an Rx side and/or a Tx side, for example, on each link. For example, the one or more sector-sweep setup parameters may include parameters to configure and/or setup the sector sweep over the 60 Ghz channel. For example, the sector-sweep setup parameters may include a number of antenna elements, a number of sectors, a minimum sector width, a Tx power, and/or an Rx sensitivity. Any other additional and/or alternative parameters may be used;
Localization information, for example, based on GPS information and/or any other additional or alternative type of localization information, e.g., as described above. For example, when available in one and/or both directions, the localization information may support the peer devices of the sector sweep procedure to identify a directional location, e.g., as described above. For example, the localization information may support the peer devices of the sector sweep procedure in selecting one or more selected sectors to be used for the sector sweep procedure. For example, the one or more selected sectors may be utilized to reduce, e.g., minimize a length of the sector sweep procedure, e.g., to a minimum sweep with the same sector size. For example, the localization information may support the peer devices of the sector sweep procedure in selecting a narrower sector size for the sector sweep procedure;
One or more channel estimates corresponding to measurements on the sub 7 GHz channel, for example, to identify an environment of the sector sweep procedure. For example, the mmWave AP 404 and/or the mmWave non-AP STA 414 may be configured to utilize the one or more channel estimates, for example, in identifying whether a LoS or a non-LoS (NLoS) is likely to exist between the two STAs. For example, the mmWave AP 404 and/or the mmWave non-AP STA 414 may be configured to utilize the one or more channel estimates, for example, in identifying a direction and/or a number of reflectors affecting a path over the mmWave channel between the two STA. In one example, the channel estimates may be obtained and/or processed, for example, by reuse of gesture recognition and/or in building location technologies;
Action timers may be used for one or more, e.g., some or all, frame exchanges, for example, over the sub-7 GHz band (lower band), and/or over the 60 GHz band;
Information about one or more networks, e.g., Basic Service Sets (BSS's), in the area; and/or
Any other additional or alternative parameters and/or any other type of information.

In some demonstrative aspects, the sub-10 GHz AP 402 and the sub-10 GHz non-AP STA 412 may be configured to exchange, share, and/or negotiate the BF-assistance parameters, e.g., via exchange of the frames 424 and 424 and/or any other additional or alternative frames over the sub-10 GHz link,, for example, prior to establishing a link over the 60 GHz frequency band.

In some demonstrative aspects, the AP device and/or the non-AP device may be configured to identify the relative positions of the mmWave AP 412 and the mmWave non-AP STA, for example, based on the BF-assistance parameters.

In one example, GPS location data, of available based on an environment, e.g., at an outdoor location, the GPS location data may be used by the AP device and/or the non-AP device to identify the relative locations, positions, and/or directionality of the two devices relative to each other.

In another example, channel estimates, e.g., at an indoor/in-building location, may be used by the AP device and/or the non-AP device to identify the relative locations, positions, and/or directionality of the two devices relative to each other.

In another example, the channel estimates, e.g., at an indoor/in-building location, may be used by the AP device and/or the non-AP device to identify information on the environment between the AP device and the non-AP device, for example, with respect to propagation/reflections, which may aid in the sector sweep procedure.

In some demonstrative aspects, channel estimation with respect to even one link may be used to enhance performance and/or assist in the sector sweep procedure.

In some demonstrative aspects, channel estimation with respect to both links may be measured and exchanged between the two devices, for example, to further enhance performance and/or assist in the sector sweep procedure.

In some demonstrative aspects, as shown in FIG. 4, an exchange between an AP device and a non-AP device may include the phase 1, which may include the exchange of the request 422 (or similar signaling) and the response 424, e.g., as described above.

In some demonstrative aspects, the request 422 and/or the response 424 may include one or more BF-assistance parameters, which may be exchanged between the AP device and the non-AP device, e.g., as described above. For example, BF-assistance parameters may include the 60 GHz channel information, and/or system parameters, e.g., number of antenna elements, sectors in sweep, minimum sector width, Tx power, or the like.

In some demonstrative aspects, as shown in FIG. 4, the sub-10 GHz AP 402 may send an implied 60 GHz trigger 426, for example, once the initial system parameters are shared in the sub-7 GHz band, and acknowledged, e.g., in either one or both directions. For example, the trigger frame 426 may be utilized to support both the STA and AP to start an acquisition process. For example, the sub-10 GHz AP 402 may be configured to send the trigger frame 426, for example, once it has secured that the 60 GHz channel is free to allow such exchange.

In some demonstrative aspects, as shown in FIG. 4, sub-10 GHz AP 402 may transmit the 60 GHz implied trigger, e.g., trigger frame 426, on the sub 7 GHz band, for example, to be used in the 60 GHz to start an enhanced sector sweep procedure, e.g., as described below.

In other aspects, the AP may transmit any other additional and/or alternative type of message, e.g., including a start time, to start the enhanced sector sweep procedure.

In some demonstrative aspects, as shown in FIG. 4, the initial frame exchange between the two STAs, may include two frames, e.g., the frames 422 and/or 424 (labeled request and response), for example, before the trigger frame 426 is sent to start a second phase (Phase 2) 430.

In other aspects, the phase 420 may include any other additional or additional frames, e.g., instead of and/or in addition to the three frames 422, 424, and 426. For example, one or more additional frames may be exchanged between the two STAs, for example, to setup and/or negotiate the parameters to configure the sector sweep procedure.

In some demonstrative aspects, the initial request for discovery and initial beamforming process may be initiated by the AP, e.g., as shown in FIG. 4. In other aspects, the initial request for discovery and initial beamforming process may be initiated by the non-AP STA. For example, the request frame 422 may be transmitted by the STA, and the response frame 424 may be transmitted by the AP.

In some demonstrative aspects, the trigger frame 426 may be configured to define parameters to be used in the phase 2.

In some demonstrative aspects, the trigger frame 426 may be configured to define a target start time to initiate the phase 2.

In some demonstrative aspects, the trigger frame 426 may be sent by the AP.

In some demonstrative aspects, the trigger frame 426 may be followed by an acknowledgement (ACK) frame, which may be sent by the client STA, e.g., in the sub-7 GHz link.

In some demonstrative aspects, as shown in FIG. 4, the AP STA and the non-AP STA may perform one or more operations of a phase (“phase 2”) 430, which may be configured to perform mmWave discovery, e.g., 60 GHz discovery, and/or initial beamforming, e.g., as described below.

In some demonstrative aspects, as shown in FIG. 4, the AP may start a sector sweep procedure 432, for example, at the time indicated in the trigger discovery frame 426, e.g., sent in the sub-7 GHz link during the phase 1.

In some demonstrative aspects, the AP may start the sector sweep procedure 432, for example, once the AP is able to access the channel, for example, if/when a channel contention mechanism over the mmWave channel indicates that the medium is idle.

In some demonstrative aspects, the sector sweep procedure 432 may include one or more operations and/or communications, for example, in accordance with the IEEE 802.11-2020 Specification. In other aspects, the sector sweep procedure 432 may include any other additional or alternative operations and/or communications.

In some demonstrative aspects, some, or even all, of the information necessary for the station to associate to the AP in the 60 GHz band may be exchanged between the AP and the STA in the sub-7 GHz link.

In some demonstrative aspects, the AP and the STA may utilize one or more, e.g., some or all, BF-assistance parameters included in the information exchanged during the phase 1, for example, to start an optimized sector sweep.

For example, the AP and the STA may utilize the location information, the channel estimation information, and/or any other additional or alternative parameters, to perform the sector sweep procedure 432, for example, as an optimized sector sweep, e.g., as described below.

In one example, the AP and/or the STA may select one or more selected sectors to be used to perform sector sweep procedure 432, for example, based on the location information and/or the channel estimation information, e.g., as described above. According to this example, the AP and/or the STA may perform the sector sweep procedure 432, for example, as a modified sector sweep, which may be relatively, e.g., significantly, shorter in duration than a sector sweep over all sectors.

In another example, the AP and/or the STA may configure relatively narrow sectors to be used to perform sector sweep procedure 432, for example, based on the location information and/or the channel estimation information, e.g., as described above. According to this example, the AP and/or the STA may perform the sector sweep procedure 432, for example, as an improved, e.g., optimized, sector sweep with narrower sector sweeping, for example, to potentially enhance an initial connection and, as a result, overall operation.

In some demonstrative aspects, PPDUs transmitted during the sector sweep 432 of the phase 2 may include a training (TRN) field. For example, the TRN field may be configured in accordance with IEEE 802.11-2020 Specification, and/or may have any other configuration.

In some demonstrative aspects, the PPDUs transmitted during the sector sweep 432 of the phase 2 may carry a Sector Sweep (SSW) frame, or a Short SSW frame, e.g., in accordance with an IEEE 802.11ad Specification and/or an IEEE 802.11ay Specification.

In some demonstrative aspects, the PPDUs transmitted during the sector sweep 432 of the phase 2 may be configured to include a new and possibly shorter frame.

In some demonstrative aspects, the PPDUs transmitted during the sector sweep 432 of the phase 2 may be configured to include Null Data Packets (NDPs) to perform the sector sweep 432.

In some demonstrative aspects, as shown in FIG. 4, the AP STA and the non-AP STA may perform one or more operations of a phase (“phase 3”) 440, which may be configured to perform discovery and initial beamforming feedback, e.g., as described below.

In some demonstrative aspects, as shown in FIG. 4, after the completion of Phase 2, the AP may trigger, e.g., using a trigger frame 442, the transmission of feedback, e.g., in a feedback frame 444, by the client STA, for example, in the sub-10 GHz link, e.g., the sub-7 GHz link.

In other aspects, exchange of the one or more BF-assistance parameters, e.g., including the location information and/or the channel estimates, during the initial frame exchange, e.g., the exchange of frames 422 and/or 424, may enhance operation between the two STAs to an extent that the link at 60 GHz may be relatively, e.g., very, reliable. As a result, the AP and the client STA may communicate the feedback, e.g., feedback frame 444, for example, directly on the 60 GHz channel.

In some demonstrative aspects, the feedback frame 444 sent by the client STA may include an indication, e.g., an index, that corresponds to the best PPDU it received during sector sweep, e.g., the PPDU with the highest SNR, or based on any other criteria; or an index list of viable sectors, e.g., all sectors that resulted in a received SNR greater than X dB, or any other criteria. In other aspects the feedback frame 444 may include any other information corresponding to the best PPDU and/or sector.

In some demonstrative aspects, the exchange for communication of the feedback frame 444 in phase 3 may be initiated by the AP, e.g., as shown in FIG. 4.

In other aspects, the exchange for communication of the feedback frame 444 in phase 3 may be performed in an unsolicited manner. For example, the STA may be configured to access the sub-7 GHz medium to send feedback frame 444 as an unsolicited frame in an unsolicited manner, e.g., such that the AP does not trigger for the feedback.

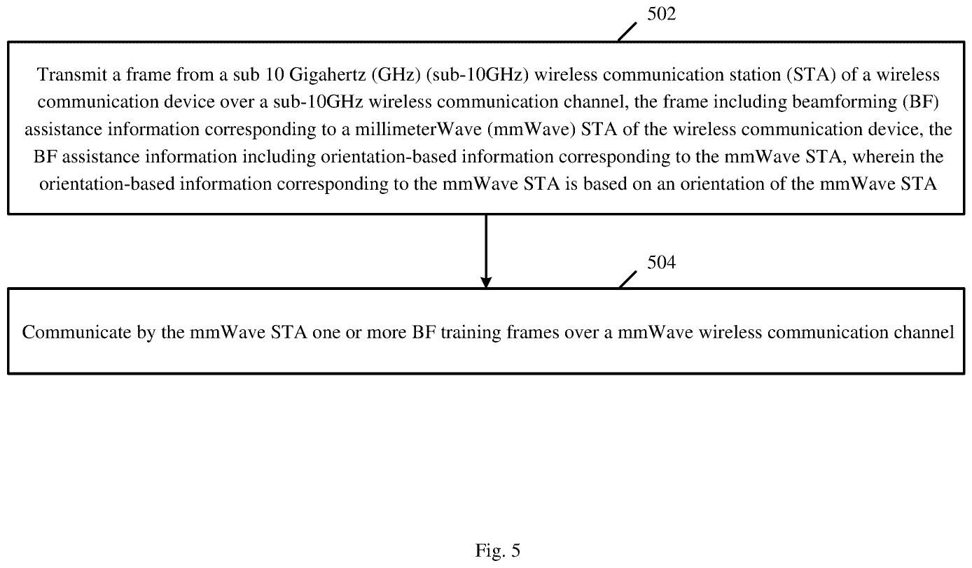

Reference is made to FIG. 5, which schematically illustrates a method of communicating over an mmWave wireless communication channel based on information communicated over a sub-10 GHz wireless communication channel, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include transmitting a frame from a sub-10 GHz STA of a wireless communication device over a sub-10 GHz wireless communication channel. For example, the frame may include BF assistance information corresponding to an mmWave STA of the wireless communication device. For example, the BF assistance information may include orientation-based information corresponding to the mmWave STA. For example, the orientation-based information corresponding to the mmWave STA may be based on an orientation of the mmWave STA. For example, controller 124 (FIG. 1) may be configured to cause, trigger, and/or control device 102 (FIG. 1) to transmit the frame from the sub-10 GHz STA of device 102 (FIG. 1) over the sub-10 GHz wireless communication channel, e.g., as described above.

As indicated at block 504, the method may include communicating by the mmWave STA one or more BF training frames over a mmWave wireless communication channel. For example, controller 124 (FIG. 1) may be configured to cause, trigger, and/or control device 102 (FIG. 1) to communicate by the mmWave STA of device 102 (FIG. 1) one or more BF training frames over an mmWave wireless communication channel, e.g., as described above.

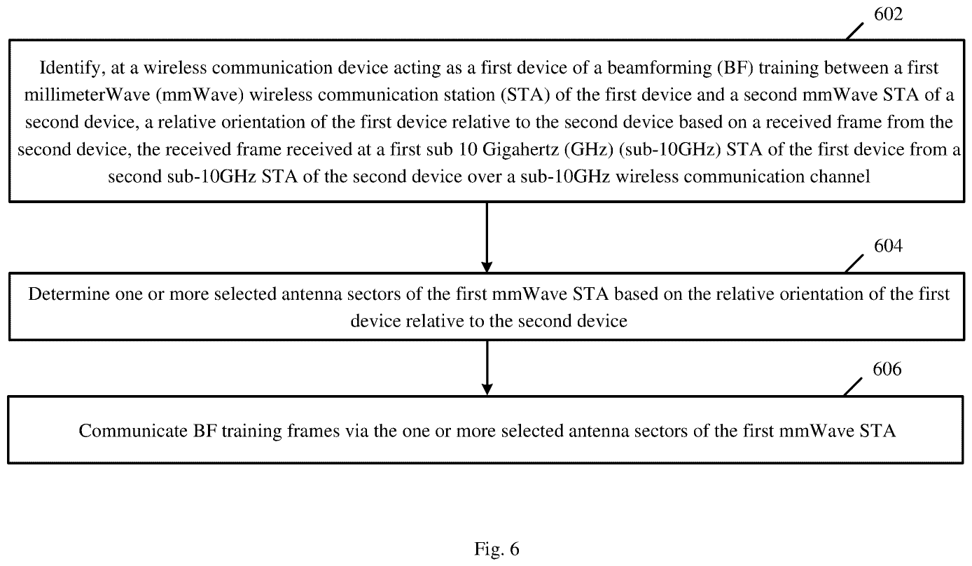

Reference is made to FIG. 6, which schematically illustrates a method of communicating over an mmWave wireless communication channel based on information communicated over a sub-10 GHz wireless communication channel, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include identifying, at a wireless communication device acting as a first device of a BF training between a first mmWave STA of the first device and a second mmWave STA of a second device, a relative orientation of the first device relative to the second device based, for example, on a received frame from the second device. For example, the received frame may be received at a first sub-10 GHz STA of the first device from a second sub-10 GHz STA of the second device over a sub-10 GHz wireless communication channel. For example, controller 154 (FIG. 1) may be configured to cause, trigger, and/or control device 140 (FIG. 1) to identify the relative orientation of device 140 (FIG. 1) relative to device 102 (FIG. 1), for example, based on the received frame from device 102 (FIG. 1), e.g., as described above.

As indicated at block 604, the method may include determining one or more selected antenna sectors of a first mmWave STA of the first device based, for example, on the relative orientation of the first device relative to the second device. For example, controller 154 (FIG. 1) may be configured to cause, trigger, and/or control device 140 (FIG. 1) to determine one or more selected antenna sectors of the mmWave STA 161 (FIG. 1), for example, based on the relative orientation of device 140 (FIG. 1) relative to device 102 (FIG. 1), e.g., as described above.

As indicated at block 606, the method may include communicating BF training frames via the one or more selected antenna sectors of the first mmWave STA. For example, controller 154 (FIG. 1) may be configured to cause, trigger, and/or control device 140 (FIG. 1) to communicate the BF training frames via the one or more selected antenna sectors of the mmWave STA 161 (FIG. 1), e.g., as described above.

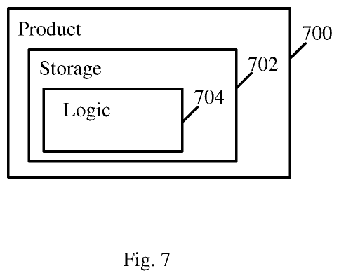

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1, 2, 3, 4, 5, and/or 6, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 700 and/or machine-readable storage media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to transmit a frame from a sub 10 Gigahertz (GHz) (sub-10 GHz) wireless communication station (STA) of the wireless communication device over a sub-10 GHz wireless communication channel, the frame comprising beamforming (BF) assistance information corresponding to a millimeterWave (mmWave) STA of the wireless communication device, the BF assistance information comprising orientation-based information corresponding to the mmWave STA, wherein the orientation-based information corresponding to the mmWave STA is based on an orientation of the mmWave STA; and communicate by the mmWave STA one or more BF training frames over an mmWave wireless communication channel.

Example 2 includes the subject matter of Example 1, and optionally, wherein the apparatus is configured to cause the wireless communication device to act as a first device comprising a first sub-10 GHz STA and a first mmWave STA to process a received frame received by the first sub-10 GHz STA over the a sub-10 GHz wireless communication channel, the received frame from a second sub-10 Ghz STA of a second device, the received frame comprising BF assistance information corresponding to a second mmWave STA of the second device; and communicate the BF training frames by the first mmWave STA based on the BF assistance information corresponding to the second mmWave STA.

Example 3 includes the subject matter of Example 2, and optionally, wherein the BF assistance information corresponding to the second mmWave STA comprises orientation-based information corresponding to the second mmWave STA, wherein the orientation-based information corresponding to the second mmWave STA is based on an orientation of the second mmWave STA.

Example 4 includes the subject matter of Example 3, and optionally, wherein the apparatus is configured to cause the wireless communication device to determine one or more selected antenna sectors of the first mmWave STA based on the orientation-based information corresponding to the second mmWave STA, and to communicate the BF training frames via the one or more selected antenna sectors of the first mmWave STA.

Example 5 includes the subject matter of Example 4, and optionally, wherein the apparatus is configured to cause the wireless communication device to determine a sector size of the one or more selected antenna sectors of the first mmWave STA based on the orientation-based information corresponding to the second mmWave STA.

Example 6 includes the subject matter of Example 4, and optionally, wherein the apparatus is configured to cause the first sub-10 GHz STA transmit to the second sub-10 GHz STA a message comprising sector information corresponding to the one or more selected antenna sectors of the first mmWave STA, wherein the sector information comprises a count of the one or more selected antenna sectors of the first mmWave STA.

Example 7 includes the subject matter of any one of Examples 3-6, and optionally, wherein the apparatus is configured to cause the wireless communication device to determine one or more excluded antenna sectors of the first mmWave STA based on the orientation-based information corresponding to the second mmWave STA, and to communicate the BF training frames according to a sector sweep of the first mmWave STA excluding the one or more excluded antenna sectors of the first mmWave STA.

Example 8 includes the subject matter of any one of Examples 3-7, and optionally, wherein the orientation-based information corresponding to the second mmWave STA comprises location information corresponding to a location of the second device.

Example 9 includes the subject matter of any one of Examples 3-8, and optionally, wherein the orientation-based information corresponding to the second mmWave STA comprises relative directionality information based on a directionality of the second mmWave STA relative to the first mmWave STA.

Example 10 includes the subject matter of any one of Examples 3-9, and optionally, wherein the orientation-based information corresponding to the second mmWave STA comprises Line-of-Sight (LoS) information based on whether a LoS exists between the second mmWave STA and the first mmWave STA.

Example 11 includes the subject matter of any one of Examples 3-10, and optionally, wherein the orientation-based information corresponding to the second mmWave STA comprises channel sounding information based on a propagation channel between the first sub-10 GHz STA and the second sub-10 GHz STA.

Example 12 includes the subject matter of any one of Examples 1-11, and optionally, wherein the orientation-based information corresponding to the mmWave STA comprises location information corresponding to a location of the wireless communication device.

Example 13 includes the subject matter of any one of Examples 1-12, and optionally, wherein the orientation-based information corresponding to the mmWave STA comprises relative directionality information corresponding to a directionality of the mmWave STA relative to another mmWave STA of another wireless communication device.

Example 14 includes the subject matter of any one of Examples 1-13, and optionally, wherein the orientation-based information corresponding to the mmWave STA comprises Line-of-Sight (LoS) information based on whether a LoS exists between the mmWave STA and another mmWave STA of another wireless communication device.

Example 15 includes the subject matter of any one of Examples 1-14, and optionally, wherein the orientation-based information corresponding to the mmWave STA comprises channel sounding information based on a propagation channel between the sub-10 GHz STA and another sub-10 GHz STA of another wireless communication device.

Example 16 includes the subject matter of any one of Examples 1-15, and optionally, wherein the frame transmitted from the sub-10 GHz STA comprises a BF setup request or a BF setup response to setup a BF procedure over the mmWave wireless communication channel.

Example 17 includes the subject matter of any one of Examples 1-15, and optionally, wherein the frame transmitted from the sub-10 GHz STA comprises an association request or an association response to setup an association between the sub-10 GHz STA and another sub-10 GHz STA of another wireless communication device.

Example 18 includes the subject matter of any one of Examples 1-17, and optionally, wherein the wireless communication device comprises an Access Point (AP) device, the sub-10 GHz STA comprises a sub-10 GHz AP, and the mmWave STA comprises an mmWave AP.

Example 19 includes the subject matter of any one of Examples 1-17, and optionally, wherein the wireless communication device comprises a non-Access Point (non-AP) device, the sub-10 GHz STA comprises a sub-10 GHz non-AP STA, and the mmWave STA comprises an mmWave non-AP STA.

Example 20 includes the subject matter of any one of Examples 1-19, and optionally, wherein the wireless communication device comprises a Multi-Link Device (MLD).

Example 21 includes the subject matter of any one of Examples 1-20, and optionally, wherein the sub-10 GHz wireless communication channel comprises a sub-7 GHz channel.

Example 22 includes the subject matter of any one of Examples 1-21, and optionally, wherein the mmWave wireless communication channel comprises a 60 GHz channel.

Example 23 includes the subject matter of any one of Examples 1-22, and optionally, comprising at least one radio to communicate the frame and the BF training frames.

Example 24 includes the subject matter of Example 23, and optionally, comprising one or more antennas connected to the radio, and a processor to execute instructions of an operating system of the wireless communication device.

Example 25 includes an apparatus comprising logic and circuitry configured to cause a wireless communication device to act as a first device of a beamforming (BF) training between a first millimeterWave (mmWave) STA of the first device and a second mmWave STA of a second device, the first device to identify a relative orientation of the first device relative to the second device based on a received frame from the second device, the received frame received at a first sub 10 Gigahertz (GHz) (sub-10 GHz) wireless communication station (STA) of the first device from a second sub-10 GHz STA of the second device over a sub-10 GHz wireless communication channel; determine one or more selected antenna sectors of the first mmWave STA based on the relative orientation of the first device relative to the second device; and communicate BF training frames via the one or more selected antenna sectors of the first mmWave STA.

Example 26 includes the subject matter of Example 25, and optionally, wherein the apparatus is configured to cause the wireless communication device to determine a sector size of the one or more selected antenna sectors of the first mmWave STA based on the relative orientation of the first device relative to the second device.

Example 27 includes the subject matter of Example 25 or 26, and optionally, wherein the apparatus is configured to cause the first sub-10 GHz STA transmit to the second sub-10 GHz STA a message comprising sector information corresponding to the one or more selected antenna sectors of the first mmWave STA, wherein the sector information comprises a count of the one or more selected antenna sectors of the first mmWave STA.

Example 28 includes the subject matter of any one of Examples 25-27, and optionally, wherein the apparatus is configured to cause the wireless communication device to determine one or more excluded antenna sectors of the first mmWave STA based on the relative orientation of the first device relative to the second device, and to communicate the BF training frames according to a sector sweep of the first mmWave STA excluding the one or more excluded antenna sectors of the first mmWave STA.

Example 29 includes the subject matter of any one of Examples 25-28, and optionally, wherein the received frame comprises BF assistance information corresponding to the second mmWave STA, the BF assistance information corresponding to the second mmWave STA comprises orientation-based information corresponding to the second mmWave STA, wherein the orientation-based information corresponding to the second mmWave STA is based on an orientation of the second mmWave STA.

Example 30 includes the subject matter of Example 29, and optionally, wherein the orientation-based information corresponding to the second mmWave STA comprises location information corresponding to a location of the second device.

Example 31 includes the subject matter of Example 29 or 30, and optionally, wherein the orientation-based information corresponding to the second mmWave STA comprises relative directionality information based on a directionality of the second mmWave STA relative to the first mmWave STA.

Example 32 includes the subject matter of any one of Examples 29-31, and optionally, wherein the orientation-based information corresponding to the second mmWave STA comprises Line-of-Sight (LoS) information based on whether a LoS exists between the second mmWave STA and the first mmWave STA.

Example 33 includes the subject matter of any one of Examples 29-32, and optionally, wherein the orientation-based information corresponding to the second mmWave STA comprises channel sounding information based on a propagation channel between the first sub-10 GHz STA and the second sub-10 GHz STA.

Example 34 includes the subject matter of any one of Examples 25-33, and optionally, wherein the received frame comprises a channel sounding frame comprising one or more channel sounding sequences.

Example 35 includes the subject matter of any one of Examples 25-34, and optionally, wherein the apparatus is configured to cause the first sub-10 GHz STA to transmit a transmitted frame comprising BF assistance information corresponding to the first mmWave STA.

Example 36 includes the subject matter of Example 35, and optionally, wherein BF assistance information corresponding to the first mmWave STA comprises orientation-based information corresponding to the first mmWave STA, wherein the orientation-based information corresponding to the first mmWave STA is based on an orientation of the first mmWave STA.

Example 37 includes the subject matter of Example 36, and optionally, wherein the orientation-based information corresponding to the first mmWave STA comprises location information corresponding to a location of the first mmWave STA.

Example 38 includes the subject matter of Example 36 or 37, and optionally, wherein the orientation-based information corresponding to the first mmWave STA comprises relative directionality information corresponding to a directionality of the first mmWave STA relative to the second mmWave STA.

Example 39 includes the subject matter of any one of Examples 36-38, and optionally, wherein the orientation-based information corresponding to the first mmWave STA comprises Line-of-Sight (LoS) information to indicate whether a LOS exists between the first mmWave STA and the second mmWave STA.

Example 40 includes the subject matter of any one of Examples 36-39, and optionally, wherein the orientation-based information corresponding to the first mmWave STA comprises channel sounding information based on a channel between the first mmWave STA and the second mmWave STA.

Example 41 includes the subject matter of any one of Examples 25-40, and optionally, wherein the received frame comprises a BF setup request or a BF setup response to setup a BF procedure over the mmWave wireless communication channel.

Example 42 includes the subject matter of any one of Examples 25-40, and optionally, wherein the received frame comprises an association request or an association response to setup an association between the first sub-10 GHz STA and the second sub-10 GHz STA.

Example 43 includes the subject matter of any one of Examples 25-42, and optionally, wherein the wireless communication device comprises an Access Point (AP) device, the first sub-10 GHz STA comprises a sub-10 GHz AP, and the first mmWave STA comprises an mmWave AP.

Example 44 includes the subject matter of any one of Examples 25-42, and optionally, wherein the wireless communication device comprises a non-Access Point (non-AP) device, the first sub-10 GHz STA comprises a sub-10 GHz non-AP STA, and the first mmWave STA comprises an mmWave non-AP STA.

Example 45 includes the subject matter of any one of Examples 25-44, and optionally, wherein the wireless communication device comprises a Multi-Link Device (MLD).

Example 46 includes the subject matter of any one of Examples 25-45, and optionally, wherein the sub-10 GHz wireless communication channel comprises a sub-7 GHz channel.

Example 47 includes the subject matter of any one of Examples 25-46, and optionally, wherein the mmWave wireless communication channel comprises a 60 GHz channel.

Example 48 includes the subject matter of any one of Examples 25-47, and optionally, comprising at least one radio to communicate the frame and the BF training frames.

Example 49 includes the subject matter of Example 48, and optionally, comprising one or more antennas connected to the radio, and a processor to execute instructions of an operating system of the wireless communication device.

Example 50 comprises a wireless communication device comprising the apparatus of any of Examples 1-49.

Example 51 comprises an apparatus comprising means for executing any of the described operations of any of Examples 1-49.

Example 52 comprises a product comprising one or more tangible computer-readable non-transitory storage media comprising instructions operable to, when executed by at least one processor, enable the at least one processor to cause a wireless communication device to perform any of the described operations of any of Examples 1-49.

Example 53 comprises an apparatus comprising: a memory interface; and processing circuitry configured to: perform any of the described operations of any of Examples 1-49.

Example 54 comprises a method comprising any of the described operations of any of Examples 1-49.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising logic and circuitry configured to cause a wireless communication device to:
transmit a frame from a sub 10 Gigahertz (GHz) (sub-10 GHz) wireless communication station (STA) of the wireless communication device over a sub-10 GHz wireless communication channel, the frame comprising beamforming (BF) assistance information corresponding to a millimeterWave (mmWave) STA of the wireless communication device, the BF assistance information comprising orientation-based information corresponding to the mmWave STA, wherein the orientation-based information corresponding to the mmWave STA is based on an orientation of the mmWave STA; and
communicate by the mmWave STA one or more BF training frames over an mmWave wireless communication channel.

27. The apparatus of claim 26 configured to cause the wireless communication device to act as a first device comprising a first sub-10 GHz STA and a first mmWave STA to:
process a received frame received by the first sub-10 GHz STA over the sub-10 GHz wireless communication channel, the received frame from a second sub-10 GHz STA of a second device, the received frame comprising BF assistance information corresponding to a second mmWave STA of the second device; and
communicate the BF training frames by the first mmWave STA based on the BF assistance information corresponding to the second mmWave STA.

28. The apparatus of claim 27, wherein the BF assistance information corresponding to the second mmWave STA comprises orientation-based information corresponding to the second mmWave STA, wherein the orientation-based information corresponding to the second mmWave STA is based on an orientation of the second mmWave STA.

29. The apparatus of claim 28 configured to cause the wireless communication device to determine one or more selected antenna sectors of the first mmWave STA based on the orientation-based information corresponding to the second mmWave STA, and to communicate the BF training frames via the one or more selected antenna sectors of the first mmWave STA.

30. The apparatus of claim 29 configured to cause the wireless communication device to determine a sector size of the one or more selected antenna sectors of the first mmWave STA based on the orientation-based information corresponding to the second mmWave STA.

31. The apparatus of claim 29 configured to cause the first sub-10 GHz STA to transmit to the second sub-10 GHz STA a message comprising sector information corresponding to the one or more selected antenna sectors of the first mmWave STA, wherein the sector information comprises a count of the one or more selected antenna sectors of the first mmWave STA.

32. The apparatus of claim 28 configured to cause the wireless communication device to determine one or more excluded antenna sectors of the first mmWave STA based on the orientation-based information corresponding to the second mmWave STA, and to communicate the BF training frames according to a sector sweep of the first mmWave STA excluding the one or more excluded antenna sectors of the first mmWave STA.

33. The apparatus of claim 26, wherein the orientation-based information corresponding to the mmWave STA comprises location information corresponding to a location of the wireless communication device.

34. The apparatus of claim 26, wherein the orientation-based information corresponding to the mmWave STA comprises relative directionality information corresponding to a directionality of the mmWave STA relative to another mmWave STA of another wireless communication device.

35. The apparatus of claim 26, wherein the orientation-based information corresponding to the mmWave STA comprises Line-of-Sight (LoS) information based on whether a LOS exists between the mmWave STA and another mmWave STA of another wireless communication device.

36. The apparatus of claim 26, wherein the orientation-based information corresponding to the mmWave STA comprises channel sounding information based on a propagation channel between the sub-10 GHz STA and another sub-10 GHz STA of another wireless communication device.

37. The apparatus of claim 26, wherein the frame transmitted from the sub-10 GHz STA comprises a BF setup request or a BF setup response to setup a BF procedure over the mmWave wireless communication channel.

38. The apparatus of claim 26, wherein the frame transmitted from the sub-10 GHz STA comprises an association request or an association response to setup an association between the sub-10 GHz STA and another sub-10 GHz STA of another wireless communication device.

39. The apparatus of claim 26, wherein the wireless communication device comprises an Access Point (AP) device, the sub-10 GHz STA comprises a sub-10 GHz AP, and the mmWave STA comprises an mmWave AP.

40. The apparatus of claim 26, wherein the wireless communication device comprises a non-Access Point (non-AP) device, the sub-10 GHz STA comprises a sub-10 GHz non-AP STA, and the mmWave STA comprises an mmWave non-AP STA.

41. The apparatus of claim 26 comprising at least one radio to communicate the frame and the BF training frames.

42. The apparatus of claim 41 comprising one or more antennas connected to the radio, and a processor to execute instructions of an operating system of the wireless communication device.

43. An apparatus comprising logic and circuitry configured to cause a wireless communication device to act as a first device of a beamforming (BF) training between a first millimeterWave (mmWave) STA of the first device and a second mmWave STA of a second device, the first device to:
identify a relative orientation of the first device relative to the second device based on a received frame from the second device, the received frame received at a first sub 10 Gigahertz (GHz) (sub-10 GHz) wireless communication station (STA) of the first device from a second sub-10 GHz STA of the second device over a sub-10 GHz wireless communication channel;
determine one or more selected antenna sectors of the first mmWave STA based on the relative orientation of the first device relative to the second device; and
communicate BF training frames via the one or more selected antenna sectors of the first mmWave STA.

44. The apparatus of claim 43 configured to cause the first sub-10 GHz STA transmit to the second sub-10 GHz STA a message comprising sector information corresponding to the one or more selected antenna sectors of the first mmWave STA, wherein the sector information comprises a count of the one or more selected antenna sectors of the first mmWave STA.

45. The apparatus of claim 43 configured to cause the wireless communication device to determine one or more excluded antenna sectors of the first mmWave STA based on the relative orientation of the first device relative to the second device, and to communicate the BF training frames according to a sector sweep of the first mmWave STA excluding the one or more excluded antenna sectors of the first mmWave STA.
